(19) United States
(12) Patent Application Publication
(10) Pub. No.: US 2023/0188443 A1
(43) Pub. Date: Jun. 15, 2023

(54) PACKET DROP ANALYSIS FOR NETWORKS

(71) Applicant: Arista Networks, Inc., Santa Clara, CA (US)

(72) Inventor: Sandip Shah, Fremont, CA (US)

(21) Appl. No.: 17/548,473

(22) Filed: Dec. 10, 2021

(51) Int. Cl. H04L 43/0829; H04L 43/062

(52) U.S. Cl. CPC H04L 43/0829; H04L 43/062

(57) ABSTRACT

Embodiments of the present disclosure include techniques for providing packet drop analysis for networks. A first stream of data comprising a copy of traffic that flows between a first network device and a third network device is received. A second stream of data comprising a copy of the traffic that flows between a fourth network device and a second network device is received. A flow in the traffic between the first and second network devices is identified. The first stream of data is used to generate a first packet count for the flow. The second stream of data is used to generate a second packet count for the flow. In response to a difference between the first packet count and the second packet count, the flow in the traffic between the first network device and the second network device is reported as having experienced one or more dropped packets.

### BACKGROUND

In computer networks, packet loss may occur when packets of data transmitted across a computer network fail to reach their intended destination. There can be many causes of packet loss. For example, errors may have occurred in the transmission of the packets of data, the computer network is experiencing network congestion (e.g., a network device is unable to handle the amount of packets it is receiving), particular network devices are configured to drop certain packets of data (e.g., a firewall device drops certain packets based on configured rules of the firewall device), there are issues with links in the computer network, etc.

The following detailed description and accompanying drawings provide a better understanding of the nature and advantages of various embodiments of the present disclosure.

### BRIEF DESCRIPTION OF THE DRAWINGS

FIG. 1 illustrates a network according to some embodiments.

FIG. 2 illustrates an example of analyzing packet drops occurring in the network illustrated in FIG. 1 according to some embodiments.

FIG. 3 illustrates an example ingress table according to some embodiments.

FIG. 4 illustrates an example egress table according to some embodiments.

FIGS. 5A and 5B illustrate example flow records according to some embodiments.

FIG. 6 illustrates a process for performing packet drop analysis according to some embodiments.

FIG. 7 illustrates an example network device according to some embodiments.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

Described herein are techniques for providing packet drop analysis for networks. In some embodiments, a data aggregator in a network may be configured to receive pairs of streams of data (e.g., an ingress stream of data and an egress stream of data) that are being communicated between two network devices in the network. Each pair of streams can monitor traffic between any two points in the network. Based on the headers of packets in a stream of data, the data aggregator identifies different flows in the stream of data. For each identified flow in a stream of data, the data aggregator maintains a count of the number of packets in the flow. Then, for each flow in a given pair of streams, the data aggregator determines whether packet drops are occurring between the corresponding two network devices in the network. The data aggregator can send a data collector in the network information associated with flows in which packet drops occurred. The data collector can use the information received from the data aggregator as well as information received from network devices in the network to generate reports regarding flows in which packets were dropped.

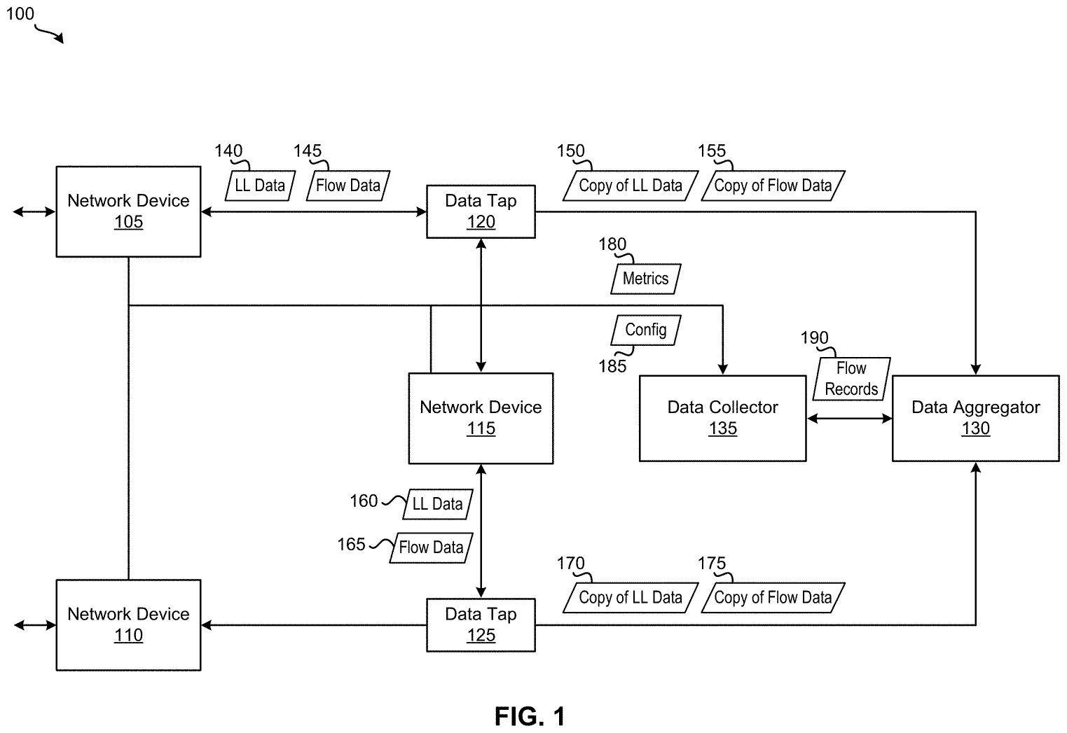

FIG. 1 illustrates a network 100 according to some embodiments. As shown, network 100 includes network devices 105-115, data taps 120 and 125, data aggregator 130, and data collector 135. Each of the network devices 105-115 is configured to forward network traffic (e.g., packets) it receives to their intended destination. The network traffic can include packet flows (also referred to as flows). In some embodiments, a packet flow includes one or more packets that each have the same set of flow identifiers. In some such embodiments, flow identifiers are stored in the header of a packer. Examples of flow identifiers include source Internet Protocol (IP) address, source port, destination IP address, destination port, protocol, etc. As illustrated, networking devices 105 and 115 are forwarding flow data 145 to each other. Additionally, networking devices 110 and 115 are forwarding flow data 165 to each other. In some embodiments, network devices 105-115 can each send, at defined intervals (e.g., once every 30 seconds, once a minute, once every five minutes, etc.) interface metrics 180 and configuration data 185 to data collector 135. Examples of interface metrics 180 includes, for each interface of a network device, transmit packet drop counters that represent the number of packets dropped by the interface, interface buffer status/level, etc. Examples of configuration data 185 include, for each network device, a list of firewall rules, a list of access control list (ACL) rules, macro-segmentation service (MSS) rules, etc. In some embodiments, a simple network management protocol (SNMP) is employed to communicate interface metrics 180 and configuration data 185. In other embodiments, a streaming telemetry technique is utilized to communicate interface metrics 180 and configuration data 185.

Each of the network devices 105-115 is also configured to exchange link level information with each other. As depicted in FIG. 1, network devices 105 and 115 exchange link level data 140. In addition, network devices 110 and 115 exchange link level data 160. Link layer data 140 and 160 each includes link level information associated with the respective network devices. Example of link level information associated with a network device include the device name and/or identifier (ID) of the network device, a port ID associated with a port of the network device through which traffic is being communicated. So if a port A of network device 105 is being used to communicate traffic to network device 115, network device 105 would send its device name and/or ID, port A, etc., to network device 115 during the link layer data exchange between network devices 105 and 115. Similarly, if a port B of network device 115 is being used to communicate traffic to network device 105, network device 115 would send its device name and/or ID, port B, etc., to network device 105 during the link layer exchange between network devices 105 and 115. The same process can be used when network devices 115 and 110 exchange their link layer information. In some embodiments, network devices 105-115 use a link layer discovery protocol (LLDP) to exchange link layer information.

Each of the data taps 120 and 125 is responsible for monitoring traffic passing through it. In some embodiments, data taps 120 and 125 can be implemented as hardware devices (e.g., network tap devices). In this example, data tap 120 monitors traffic transmitted between network devices 105 and 115. Specifically, data tap 120 passes traffic transmitted between network devices 105 and 115 (e.g., link level data 140 and flow data 145), generates a copy of the traffic, and sends them to data aggregator 130. In this example, copy of link level data 150 and copy of flow data 155 are copies of link level data 145 and flow data 145, respectively. For this example, data tap 125 monitors traffic transmitted between network devices 110 and 115. In particular, data tap 125 passes traffic transmitted between network devices 110 and 115 (e.g., link level data 160 and flow data 165), generates a copy of the traffic, and sends them to data aggregator 130. Here, copy of link level data 170 and copy of flow data 175 are copies of link level data 160 and flow data 165, respectively.

While FIG. 1 shows data taps being used to generate a copy of the traffic that flows between network devices and send the copy to data aggregator 130, other techniques are possible. For instance, instead of using data tap 120, a port on network device 105 may be configured to mirror (e.g., generate a copy of) the traffic transmitted between network devices 105 and 115. This port on network device 105 can be physically connected to a port on data aggregator 130, which allows network device 105 to transmit the mirrored traffic to data aggregator 130. Similarly, instead of using data tap 125, a port on network device 110 can be configured to mirror (e.g., generate a copy of) the traffic transmitted between network devices 110 and 115. This port on network device 110 may be physically connected to a port on data aggregator 130, thereby allowing network device 110 to transmit the mirrored traffic to data aggregator 130.

Data aggregator 130 is configured to determine whether packets are being dropped from traffic transmitted between network devices. In this example, data aggregator 130 is configured to determine whether packets are being dropped from traffic transmitted between network devices 105 and 110. As shown in FIG. 1, data aggregator 130 receives copies of link level data 150 and link level data 170. Based on this link level information, data aggregator 130 can determine that data received from data tap 120 (i.e., data received at the port of data aggregator 130 connected to data tap 120) is traffic transmitted between network devices 105 and 115 and data received from data tap 125 (i.e., data received at the port of data aggregator 130 connected to data tap 125) is traffic transmitted between network devices 110 and 115.

Data aggregator 130 can determine whether packets are being dropped from traffic transmitted between network devices 105 and 110 based on copies of flow data 155 received from data tap 120 and copies of flow data 175 received from data tap 125. For each flow in copies of flow data 155, data aggregator 130 maintains a count of the number of packets received for the flow. Data aggregator 130 does the same for each flow in copies of flow data 175. At defined intervals (e.g., once a minute, once every three minutes, once every five minutes, once every ten minutes, etc.), data aggregator 130 determines whether packet drops have occurred in the packet flows. In some embodiments, data aggregator 130 makes this determination by comparing the number of packets counted for each flow in copies of flow data 155 with the number of packets counted for the corresponding same flow in copies of flow data 175 (if it exists). Based on the comparisons, data aggregator 130 determines the flows that have packet drops. For each such flow, data aggregator 130 generates a flow record 190 and sends it to data collector 135. In some embodiments, data aggregator 130 generates flow records using an Internet Protocol Flow Information Export (IPFIX) protocol.

Data collector 135 handles the collection of data and generation of packet drop reports. For example, data collector 135 can receive interface metrics and configuration information one or more network devices in network 100. Here, data collector 135 receives interface metrics 180 and configuration data 185 from network device 115. Data collector 135 also receives flow records 190 from data aggregator 130. Based on flow records 190, interface metrics 180, and configuration data 185, data collector 135 generates a report for each flow in which packet drops occurred. In some embodiments, a report that data collector 135 generates for a flow in which packet drops occurred includes a flow record associated with the flow and a set of reasons why the packet drop occurred. Data collector 135 can determine a set of reasons why packet drops occurred for a flow based on interface metrics 180 and configuration data 185. For example, for a given flow that experienced packet drops, data collector 135 may determine a set of reasons why the packet drops occurred by checking for firewall rules, ACL rules, MSS rules, etc., in the configuration data 185 of each of network devices 105-115. Then, data collector 135 determines whether applying any of the rules to the flow would cause the packets in the flow to be blocked and/or dropped. If any such rule(s) exist, data collector 135 determines that a reason the flow experienced packet drops is because the network device configured with this rule(s) blocked and/or dropped packets in the flow. If none such rules exist, data collector 135 analyzes the interface metrics associated with interfaces of network devices 105-115 to determine if any the interface metrics indicate congestion occurred on the respective interface. For instance, a transmit packet drop counter associated with an interface that has a larger value can indicate that the interface experienced network traffic congestion, which caused the packet drops in the flow. As another example, if an interface buffer status/level associated with an interface is high or full, that may indicate that the interface experienced network traffic congestion and, in turn, caused the packet drops in the flow. When data collector 135 determines a set of reasons for why the packet drops occurred for a flow that experienced packet drops, data collector 135 adds the set of reasons to the flow record 190 associated with the flow. Then, data collector 135 stores the modified flow record 190 (i.e., the packet drop report for the flow) in a storage (not shown) for later access.

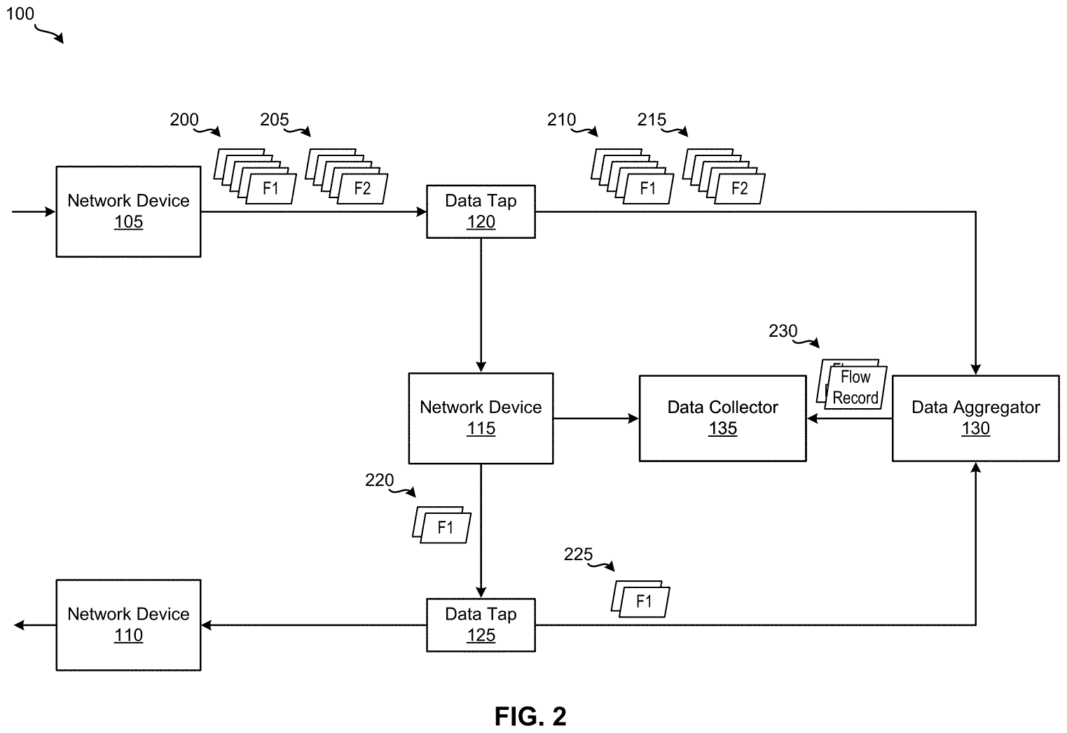

FIG. 2 illustrates an example of analyzing packet drops occurring in network 100 according to some embodiments. Specifically, this example shows how traffic transmitted from network device 105 to network device 110 is analyzed for packet drops. Here, network devices 105-115 have exchanged link level information in the same manner as that described above. As such, data aggregator 130 has already received from data taps 120 and 125 copies of the link level information that were exchanged between network devices 105-115. In addition, network devices 105-115 are each sending, at defined intervals, interface metrics and configuration data to data collector 135 (not shown in FIG. 2). In this example, network device 105 sends network device 115 five packets in packet flow 200 (flow F1) and five packets in packet flow 205 (flow F2), which are destined for network device 110. Each packet in packet flow 200 has the same set of flow identifiers (e.g., source IP address, source port, destination IP address, destination port, and protocol). Each packet in packet flow 205 has the same set of flow identifiers. However, the set of flow identifiers of packets in packet flow 200 are different then the set of flow identifiers of packets in packet flow 205.

When data tap 120 receives a packet in packet flow 200 or packet flow 205, data tap 120 generates a copy of it, sends the copy of the packet to data aggregator 130, and passes the received packet to network device 115. As depicted in FIG. 2, data tap 120 sends copy of packet flow 210, which is a copy of packet flow 200, and copy of packet flow 215, which is a copy of packet flow 205, to data aggregator 130. For this example, upon receiving a packet in packet flow 205 from data tap 120, network device 115 does not forward it (e.g., an access control list or firewall rule was trigged causing network device 115 to drop the packet, network device 115 could not handle the packet at the time, etc.). Additionally, network device 115 is able to forward to data tap 125 two out of the five packets in packet flow 220 that network device 115 received from data tap 120 (e.g., network device 115 could only handle two packets at the time, etc.). The two packets are represented as packet flow 220. Once data tap 125 receives a packet from network device 115, data tap 125 generates a copy of it, sends the copy of the packet to data aggregator 130, and passes the received packet to network device 110. As shown, data tap 125 sends copy of packet flow 225, which is a copy of packet flow 220, to data aggregator 130.

In some embodiments, data aggregator 130 maintains of table of flow data for each stream of traffic it receives (e.g., traffic received at each port on data aggregator). Here, data aggregator 130 maintains two tables: a first table for the stream of traffic received from data tap 120 at a first port of data aggregator 130 and a second table for the stream of traffic received from data tap 125 at a second port of data aggregator 130. For this example, the first table is referred to as an ingress table and the second table is referred to as an egress table. When data aggregator 130 receives a packet for a new packet flow (e.g., a packet that has a set of flow identifiers that data aggregator 130 has not received before), data aggregator 130 creates a new entry in the corresponding table, uses the set of flow identifiers as the key of the entry, and sets, as the value for the entry, the packet count for that packet flow to 1. As data aggregator 130 receives packets belonging to that packet flow, data aggregator 130 increments the packet count in that entry in the table. In this example, once data aggregator 130 receives a first packet in flow F1 (e.g., a packet in copy of packet flow 210), data aggregator 130 creates an entry in the ingress table, uses the set of flow identifiers of the packet as the key of the entry, and sets, as the value for the entry, the packet count for that packet flow to 1. When data aggregator 130 receives a second packet belonging to packet flow F1 (e.g., a second packet in copy of packet flow 210), data aggregator 130 increments the value of this entry in the ingress table to 2. Data aggregator 130 continues to increment the value for this entry in the ingress table as it receives packets belonging to packet flow F1. Based on the packets that Data aggregator 130 maintains packet counts in the ingress table for the packets it receives from data tap 120. In the same fashion, data aggregator 130 maintains packet counts in the egress table for packets it receives from data tap 125.

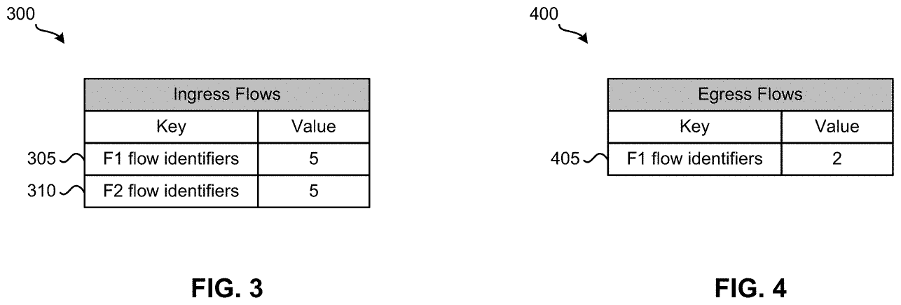

FIG. 3 illustrates an example ingress table 300 according to some embodiments. In particular, ingress table 300 is the ingress table that data aggregator 300 uses in this example. As illustrated, ingress table 300 includes a key column and a value column. The key column is configured to store a set of flow identifiers. The value column is configured to store a count of the number of packets received for the corresponding flow. FIG. 3 also shows the state of ingress table 300 after data aggregator 130 receives all the packets in copy of packet flow 210 and copy of packet flow 215. As depicted, ingress table 300 also includes two entries 305 and 310. Entry 305 is for packet flow F1 and entry 310 is for packet flow F2. As data aggregator 130 received five packets belonging to each of the flows F1 and F2, the values (i.e., the packet counts) for each of the entries 305 and 310 is 5.

FIG. 4 illustrates an example egress table 400 according to some embodiments. Specifically, egress table 400 is the egress table that data aggregator 300 uses for this example. As shown in FIG. 4, egress table 400 includes a key column and a value column. The key column is configured to store a set of flow identifiers and the value column is configured to store a count of the number of packets received for the corresponding flow. In addition, FIG. 4 shows the state of egress table 400 after data aggregator 130 receives all the packets in copy of packet flow 225. As illustrated, egress table 400 also includes an entry 405. Entry 405 is for packet flow F1. Since data aggregator 130 received two packets belonging to packet flow F1, the value (i.e., the packet count) for entry 405 is 2.

Returning to FIG. 2, data aggregator 130 determines whether packet drops have occurred in the packet flows at defined intervals, as mentioned above. Here, at a defined interval, the state of the ingress table and the egress table is what is depicted in FIGS. 3 and 4. Data aggregator 130 starts by iterating to the first entry (entry 305 in this example) in ingress table 300 and identifying an entry in egress table 400 that has the same set of flow identifiers as the first entry in ingress table 300. For this example, data aggregator 130 identifies entry 405 as the entry that matches entry 305. Next, data aggregator 130 compares the values in entries 305 and 405. Because there is a difference in the packet count values in these entries, data aggregator 130 determines that a partial packet drop occurred in packet flow F1. In particular, 3 packets were dropped from the 5 that were transmitted. Then, data aggregator 130 iterates to the next entry in ingress table (entry 310 in this example) and identifies an entry in egress table 400 that has the same set of flow identifiers as entry 310. No such entry exists in egress table 400. Therefore, data aggregator 130 determines that a full packet drop occurred in packet flow F2. Specifically, the 5 packets that were transmitted were dropped. For each of the packet flows that experienced packet drops (packet flows F1 and F2 in this example), data aggregator 130 generates a flow record and sends it to data collector 135. As illustrated, data aggregator 130 generates flow records 230: a first flow record for packet flow F1 and a second flow record for packet flow F2. As explained above, data aggregator 130 can generate flow records using an Internet Protocol Flow Information Export (IPFIX) protocol in some embodiments.

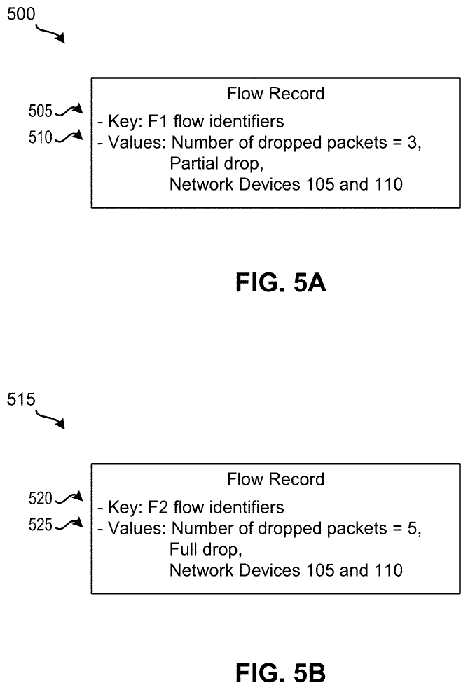

FIGS. 5A and 5B illustrate example flow records 500 and 515 according to some embodiments. In particular, flow record 500 is the flow record 230 that data aggregator 130 generates for packet flow F1 and flow record 515 is the flow record 230 that data aggregator 130 generates for packet flow F2. As depicted in FIG. 5A, flow record 500 includes key 505 and values 510. Key 505 includes the set of flow identifiers for packet flow F1 (e.g., source IP address, source port, destination IP address, destination port, and protocol). Values 510 includes the number of dropped packets (3 in this example) in packet flow F1, the type of packet drop (partial in this example), and the network devices that were monitored (networking devices 105 and 110 in this example). As shown in FIG. 5B, flow record 515 includes key 520 and values 525. Key 520 includes the set of flow identifiers for packet flow F2 (e.g., source IP address, source port, destination IP address, destination port, and protocol). Values 525 includes the number of dropped packets (5 in this example) in packet flow F1, the type of packet drop (full in this example), and the network devices that were monitored (networking devices 105 and 110 in this example).

Returning to FIG. 2, after generating flow records 230, data aggregator 130 sends them to data collector 135. Upon receiving flow records 230 from data aggregator 130, data collector 135 generates reports for each of the packet flows that experienced packet drops. As mentioned above, data collector 135 receives, at defined intervals, interface metrics and configuration data from network devices 105-115. Based on flow records 230, the interface metrics, and the configuration data, data collector 135 generates reports for packet flow F1 and packet flow F2. In particular, data collector 135 generates the reports for packet flow F1 and packet flow F2 based on flow records 230, the interface metrics, and the configuration data in the same manner described above (i.e., determining a set of reasons why the packet drops occurred and adding the set of reasons to the flow record associated with the flow).

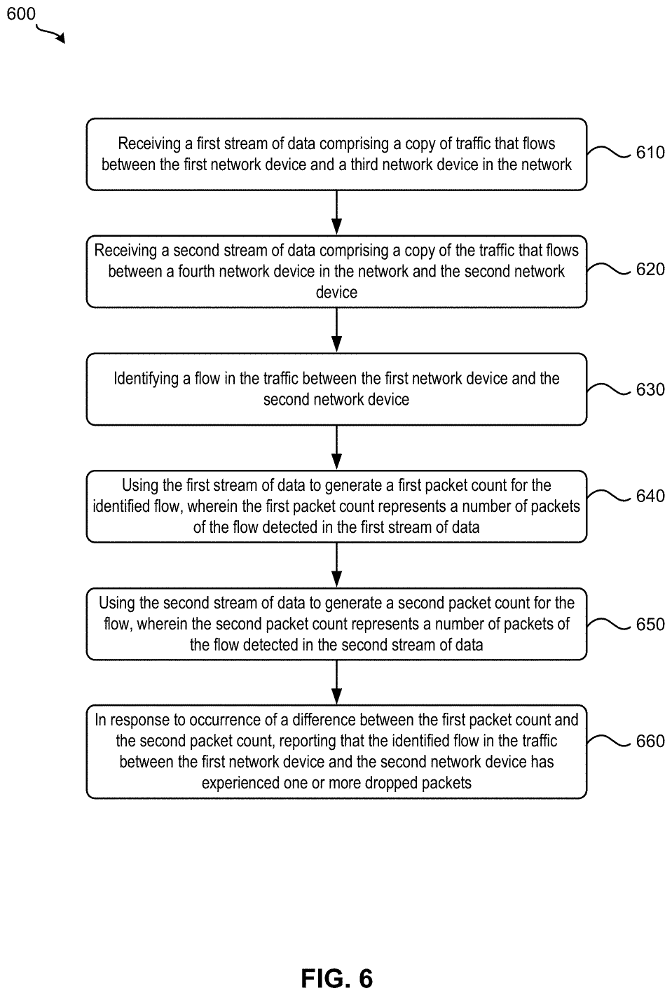

FIG. 6 illustrates a process 600 for performing packet drop analysis according to some embodiments. In some embodiments, data aggregator 130 performs process 600. Process 600 begins by receiving, at 610, a first stream of data comprising a copy of traffic that flows between the first network device and a third network device in the network. Referring to FIG. 2 as an example, data aggregator 130 can receive copies of packet flows 210 and 215 from data tap 120, which generates a copy of traffic flowing between network devices 105 and 115.

Next, process 600 receives, at 620, a second stream of data comprising a copy of the traffic that flows between a fourth network device in the network and the second network device. Referring to FIG. 2 as an example, data aggregator 130 may receive copy of packet flow 225 from data tap 125, which generates a copy of traffic flowing between network devices 110 and 115. At 630, process 600 identifies a flow in the traffic between the first network device and the second network device. Referring to FIG. 2 as an example, data aggregator 130 identifies packet flow F1.

Process 600 then uses, at 640, the first stream of data to generate a first packet count for the identified flow. The first packet count represents a number of packets of the flow detected in the first stream of data. Referring to FIGS. 2 and 3 as an example, data aggregator 130 uses the copies of packet flows 210 and 215 to generate a packet count for packet flow F1 (5 in this example).

Then, process 600 uses, at 650, the second stream of data to generate a second packet count for the flow. The second packet count represents a number of packets of the flow detected in the second stream of data. Referring to FIGS. 2 and 4 as an example, data aggregator 130 uses the copies of packet flow 225 to generate a packet count for packet flow F1 (2 in this example).

Finally, in response to occurrence of a difference between the first packet count and the second packet count, process 600 reports, at 660, that the identified flow in the traffic between the first network device and the second network device has experienced one or more dropped packets. Referring to FIGS. 2 and 5A as an example, data aggregator 130 generates a flow record 230 indicating that packet flow F1 has experienced dropped packets.

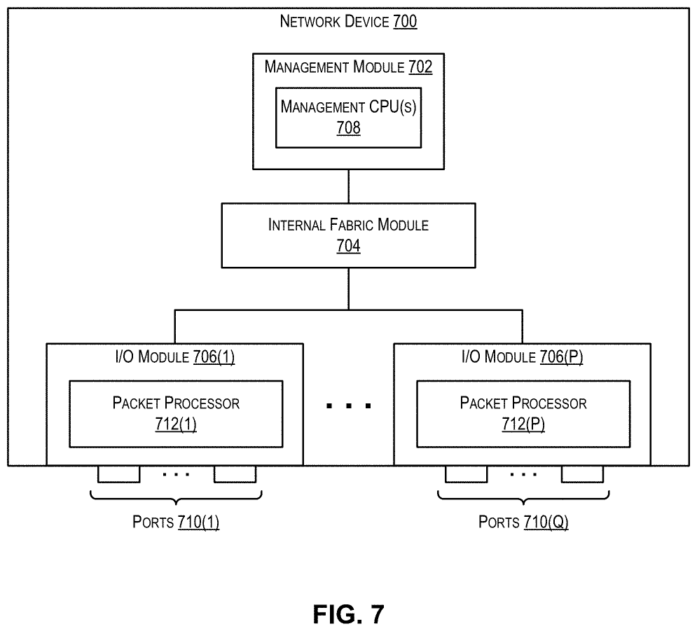

FIG. 7 illustrates the architecture of an example network device (e.g., a network switch or router) 700 that may implement the techniques of the present disclosure according to certain embodiments. For example, network device 700 may correspond to network device 100 shown in FIG. 1.

Network device 700 includes a management module 702, an internal fabric module 704, and a number of I/O modules 706(1)-(P). Management module 702 includes one or more management CPUs 708 for managing/controlling the operation of the device. Each management CPU 708 can be a general-purpose processor, such as an Intel/AMD x86 or ARM-based processor, that operates under the control of program code maintained in an associated volatile memory and/or stored in a non-transitory computer readable storage medium (not shown). In one set of embodiments, this program code can include code for implementing some or all of the techniques described in the foregoing sections.

Internal fabric module 704 and I/O modules 706(1)-(P) collectively represent the data, or forwarding, plane of network device 700. Internal fabric module 704 is configured to interconnect the various other modules of network device 700. Each I/O module 706 includes one or more input/output ports 710(1)-(Q) that are used by network device 700 to send and receive network packets. Each I/O module 706 can also include a packet processor 712, which is a hardware processing component that can make wire speed decisions on how to handle incoming or outgoing network packets.

It should be appreciated that network device 700 is illustrative and other configurations having more or fewer components than network device 700 are possible.

The following are some example embodiments of the present disclosure. In some embodiments, a method is for reporting on packet drops in traffic between a first network device and a second network device in a network. The method comprises receiving a first stream of data comprising a copy of traffic that flows between the first network device and a third network device in the network; receiving a second stream of data comprising a copy of the traffic that flows between a fourth network device in the network and the second network device; identifying a flow in the traffic between the first network device and the second network device; using the first stream of data to generate a first packet count for the identified flow, wherein the first packet count represents a number of packets of the flow detected in the first stream of data; using the second stream of data to generate a second packet count for the flow, wherein the second packet count represents a number of packets of the flow detected in the second stream of data; and, in response to occurrence of a difference between the first packet count and the second packet count, reporting that the identified flow in the traffic between the first network device and the second network device has experienced one or more dropped packets.

In some embodiments, the present disclosure further identifies a source and destination of the identified flow using information contained in the first and second stream of data, wherein the reporting includes the source and destination of the flow.

In some embodiments, the present disclosure further receives configuration and interface metrics for the first and second network devices, wherein the reporting includes the configuration and interface metrics for the first and second network devices.

In some embodiments, the present disclosure further receives configuration and interface metrics for the third and fourth network devices, wherein the reporting includes the configuration and interface metrics for the third and fourth network devices.

In some embodiments, the identified flow comprises data packets that each includes the same set of flow identifiers.

In some embodiments, the present disclosure further counts packets comprising the identified flow in the first stream of data for a predetermined period of time to generate the first packet count and counts packets comprising the identified flow in the second stream of data for the predetermined period of time to generate the second packet count.

In some embodiments, the first stream of data is received from a first tap device configured to receive the traffic between the first network device and the third network device and generate the copy of the traffic that flows between the first network device and the third network device. The second stream of data is received from a second tap device configured to receive the traffic between the fourth network device and the second network device and generate the copy of the traffic that flows between the fourth network device and the second network device.

In some embodiments, the first stream of data is received from a first port of the first network device, the first port configured to generate the copy of the traffic that flows between a second port of the first network device and the third network device. The second stream of data is received from a third port of the second network device, the third port configured to generate the copy of the traffic that flows between the fourth network device and a fourth port of the second network device.

In some embodiments, the third network device and the fourth network device are the same.

In some embodiments, a non-transitory machine-readable medium stores a program executable by at least one processing unit of a device in a network. The program comprising sets of instructions for receiving a first stream of data comprising a copy of traffic that flows between a first network device and a third network device in the network; receiving a second stream of data comprising a copy of the traffic that flows between the third network device and a second network device in the network; identifying a flow in the traffic between the first network device and the second network device; using the first stream of data to generate a first packet count for the identified flow, wherein the first packet count represents a number of packets of the flow detected in the first stream of data; using the second stream of data to generate a second packet count for the flow, wherein the second packet count represents a number of packets of the flow detected in the second stream of data; and, in response to occurrence of a difference between the first packet count and the second packet count, reporting that the identified flow in the traffic between the first network device and the second network device has experienced one or more dropped packets.

In some embodiments, a system comprise a set of processing units and a non-transitory machine-readable medium that stores instructions. The set of processing units cause at least one processing unit to receive a first stream of data comprising a copy of a first portion of traffic that flows between a first network device and a second network device in a network; receive a second stream of data comprising a copy of a second portion of traffic that flows between the first network device and the second network device; identify a flow in the traffic between the first network device and the second network device; use the first stream of data to generate a first packet count for the identified flow, wherein the first packet count represents a number of packets of the flow detected in the first stream of data; use the second stream of data to generate a second packet count for the flow, wherein the second packet count represents a number of packets of the flow detected in the second stream of data; and, in response to occurrence of a difference between the first packet count and the second packet count, report that the identified flow in the traffic between the first network device and the second network device has experienced one or more dropped packets.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method for reporting on packet drops in traffic between a first network device and a second network device in a network, the method comprising:
receiving a first stream of data comprising a copy of traffic that flows between the first network device and a third network device in the network;
receiving a second stream of data comprising a copy of the traffic that flows between a fourth network device in the network and the second network device;
identifying a flow in the traffic between the first network device and the second network device;
using the first stream of data to generate a first packet count for the identified flow, wherein the first packet count represents a number of packets of the flow detected in the first stream of data;
using the second stream of data to generate a second packet count for the flow, wherein the second packet count represents a number of packets of the flow detected in the second stream of data; and
in response to occurrence of a difference between the first packet count and the second packet count, reporting that the identified flow in the traffic between the first network device and the second network device has experienced one or more dropped packets.

2. The method of claim 1 further comprising identifying a source and destination of the identified flow using information contained in the first and second stream of data, wherein the reporting includes the source and destination of the flow.

3. The method of claim 1 further comprising receiving configuration and interface metrics for the first and second network devices, wherein the reporting includes the configuration and interface metrics for the first and second network devices.

4. The method of claim 1 further comprising receiving configuration and interface metrics for the third and fourth network devices, wherein the reporting includes the configuration and interface metrics for the third and fourth network devices.

5. The method of claim 1, wherein the identified flow comprises data packets that each includes the same set of flow identifiers.

6. The method of claim 1 further comprising:
counting packets comprising the identified flow in the first stream of data for a predetermined period of time to generate the first packet count; and
counting packets comprising the identified flow in the second stream of data for the predetermined period of time to generate the second packet count.

7. The method of claim 1, wherein the first stream of data is received from a first tap device configured to receive the traffic between the first network device and the third network device and generate the copy of the traffic that flows between the first network device and the third network device, wherein the second stream of data is received from a second tap device configured to receive the traffic between the fourth network device and the second network device and generate the copy of the traffic that flows between the fourth network device and the second network device.

8. The method of claim 1, wherein the first stream of data is received from a first port of the first network device, the first port configured to generate the copy of the traffic that flows between a second port of the first network device and the third network device, wherein the second stream of data is received from a third port of the second network device, the third port configured to generate the copy of the traffic that flows between the fourth network device and a fourth port of the second network device.

9. The method of claim 1, wherein the third network device and the fourth network device are the same.

10. A non-transitory machine-readable medium storing a program executable by at least one processing unit of a device in a network, the program comprising sets of instructions for:
receiving a first stream of data comprising a copy of traffic that flows between a first network device and a third network device in the network;
receiving a second stream of data comprising a copy of the traffic that flows between the third network device and a second network device in the network;
identifying a flow in the traffic between the first network device and the second network device;
using the first stream of data to generate a first packet count for the identified flow, wherein the first packet count represents a number of packets of the flow detected in the first stream of data;
using the second stream of data to generate a second packet count for the flow, wherein the second packet count represents a number of packets of the flow detected in the second stream of data; and
in response to occurrence of a difference between the first packet count and the second packet count, reporting that the identified flow in the traffic between the first network device and the second network device has experienced one or more dropped packets.

11. The non-transitory machine-readable medium of claim 10, wherein the program further comprises a set of instructions for identifying a source and destination of the identified flow using information contained in the first and second stream of data, wherein the reporting includes the source and destination of the flow.

12. The non-transitory machine-readable medium of claim 10, wherein the program further comprises a set of instructions for receiving configuration and interface metrics for the first and second network devices, wherein the reporting includes the configuration and interface metrics for the first and second network devices.

13. The non-transitory machine-readable medium of claim 10, wherein the program further comprises a set of instructions for receiving configuration and interface metrics for the third and fourth network devices, wherein the reporting includes the configuration and interface metrics for the third and fourth network devices.

14. The non-transitory machine-readable medium of claim 10, wherein the identified flow comprises data packets that each includes the same set of flow identifiers.

15. The non-transitory machine-readable medium of claim 10, wherein the program further comprises sets of instructions for:
counting packets comprising the identified flow in the first stream of data for a predetermined period of time to generate the first packet count; and
counting packets comprising the identified flow in the second stream of data for the predetermined period of time to generate the second packet count.

16. The non-transitory machine-readable medium of claim 10, wherein the first stream of data is received from a first tap device configured to receive the traffic between the first network device and the third network device and generate the copy of the traffic that flows between the first network device and the third network device, wherein the second stream of data is received from a second tap device configured to receive the traffic between the fourth network device and the second network device and generate the copy of the traffic that flows between the fourth network device and the second network device.

17. The non-transitory machine-readable medium of claim 10, wherein the first stream of data is received from a first port of the first network device, the first port configured to generate the copy of the traffic that flows between a second port of the first network device and the third network device, wherein the second stream of data is received from a third port of the second network device, the third port configured to generate the copy of the traffic that flows between the fourth network device and a fourth port of the second network device.

18. A system comprising:
a set of processing units; and
a non-transitory machine-readable medium storing instructions that when executed by at least one processing unit in the set of processing units cause the at least one processing unit to:
receive a first stream of data comprising a copy of a first portion of traffic that flows between a first network device and a second network device in a network;
receive a second stream of data comprising a copy of a second portion of traffic that flows between the first network device and the second network device;
identify a flow in the traffic between the first network device and the second network device;
use the first stream of data to generate a first packet count for the identified flow, wherein the first packet count represents a number of packets of the flow detected in the first stream of data;
use the second stream of data to generate a second packet count for the flow, wherein the second packet count represents a number of packets of the flow detected in the second stream of data; and
in response to occurrence of a difference between the first packet count and the second packet count, report that the identified flow in the traffic between the first network device and the second network device has experienced one or more dropped packets.

19. The system of claim 18, wherein the instructions further cause the at least one processing unit to identifying a source and destination of the identified flow using information contained in the first and second stream of data, wherein the reporting includes the source and destination of the flow.

20. The system of claim 18, wherein the instructions further cause the at least one processing unit to:
count packets comprising the identified flow in the first stream of data for a predetermined period of time to generate the first packet count; and
count packets comprising the identified flow in the second stream of data for the predetermined period of time to generate the second packet count.
